(19) United States
(12) Patent Application Publication
(10) Pub. No.: US 2012/0006468 A1
(43) Pub. Date: Jan. 12, 2012

(54) INLINE PLASMA TREATMENT OF AN OPTICAL FIBER CABLE STRUCTURE

(75) Inventors: Paul Stopford, Southampton (GB); Dominic Brady, Winchester (GB)

(73) Assignee: SCHLUMBERGER TECHNOLOGY CORPORATION, SUGAR LAND, TX (US)

(21) Appl. No.: 12/831,999

(22) Filed: Jul. 7, 2010

(51) Int. Cl. B29C 53/32; G02B 6/02

(52) U.S. Cl. 156/175; 156/272.6

(57) ABSTRACT

To treat a surface of an optical fiber cable structure, substantially an entire length of the optical fiber cable structure is moved through an inline plasma treatment system. As the optical fiber cable structure is moved through the inline plasma treatment system, the surface of the optical fiber cable structure is continually exposed to plasma. Exposing the surface of the optical fiber cable structure to plasma modifies a characteristic of the surface of the optical cable structure to improve an ability of the surface of the optical fiber cable structure to adhere to a target material.

### BACKGROUND

Interferometric sensors may be used to measure a variety of different physical parameters. For instance, an interferometric sensor may be used with an optical fiber that is deployed through a region of interest. When light is launched into the fiber, the sensor (or reflector) returns backreflected optical radiation that then may be analyzed to determine variations in a parameter of interest, such as pressure, temperature, strain, etc. Such sensors have proven to be useful in a variety of applications, such as in hydrocarbon production applications, applications for identifying and determining a variety of downhole properties (e.g., pressure, vibration, temperature, fluid flow characteristics, etc.), and so forth.

For downhole applications in wells, an optical fiber can be coated with a protective material such as high-temperature polymer (e.g., polyimide). The high-temperature polymer allows the optical fiber to survive relatively high temperatures and other harsh conditions that are typically present in the well. However, an issue associated with polymer-coated optical fibers is that it is often difficult to reliably coat other structures to the optical fibers for forming composite sensor assemblies.

### SUMMARY

In general, according to an embodiment, a method of treating a surface of an optical fiber cable structure includes moving substantially an entire length of the optical fiber cable structure through an inline plasma treatment system. As the optical fiber cable structure is moved through the inline plasma treatment system, the surface of the optical fiber cable structure is continually exposed to plasma. Exposing the surface of the optical fiber cable structure to plasma modifies a characteristic of the surface of the optical cable structure to improve an ability of the surface of the optical fiber cable structure to adhere to a target material.

Other or alternative features will become apparent from the following description, from the drawings, and from the claims.

### BRIEF DESCRIPTION OF THE DRAWINGS

Some embodiments of the invention are described with respect to the following figures:

FIG. 1 is a schematic diagram of an example system for treating an optical fiber cable structure, according to an embodiment;

FIGS. 2A-2B are schematic diagrams of systems for treating an optical fiber cable structure according to another embodiment;

FIGS. 3 and 4 are cross-sectional views of portion of optical fiber composite structures formed according to some embodiments of the invention; and

FIG. 5 is a flow diagram of a process of making an optical fiber assembly according to an embodiment.

### DETAILED DESCRIPTION

In accordance with some embodiments, techniques or mechanisms are provided to perform treatment of a surface of an optical fiber cable structure to enhance an ability of the surface to adhere to a target structure. The optical fiber cable structure can include an optical fiber that is surrounded by a cladding layer for protection of the optical fiber. In some implementations, the cladding layer can be formed of a polymer, such as polyimide. For example, the optical fiber can be coated with (or otherwise attached to) a layer (or multiple layers) of polymer. In other examples, other types of protective materials can be used for the cladding layer.

For applications in which an optical fiber is deployed downhole into a well, the polymer layer surrounding the optical fiber provides protection from relatively harsh conditions in the wellbore, which can include high temperatures, corrosive fluids, and so forth. Although reference is made to deploying assemblies including optical fibers into wells, it is noted that other assemblies including optical fibers can be used in other environments.

In one specific example, the treated optical fiber cable structure can be used as part of an optical fiber sensor assembly to perform sensing of one or more parameters of interest. In a downhole application, the optical fiber sensor assembly can be used to detect downhole temperatures, pressures, strains, and so forth, in a well.

Optical fiber sensor assemblies are associated with various benefits, including high sensitivity, immunity to electromagnetic interference (EMI), electrical passivity, multiplexability, relatively high reliability, and relatively low cost. However, use of optical fiber sensor assemblies in harsh, high-temperature environments may be limited by the presence of the polymer layers around the optical fibers, since the polymer layers may have relatively poor bonding or adhesion characteristics.

An optical fiber assembly is normally formed of a composite arrangement of several materials, including the optical fiber, cladding layer around the optical fiber, and further structures attached to the cladding layer. For example, the optical fiber can be embedded into a mold-based resin transfer molding (RTM) composite structure.

An issue associated with use of polymer in a cladding layer around an optical fiber is that polymer surfaces are generally difficult to adhere to. The relatively excellent bulk properties of polymers such as thermal and mechanical stability, toughness, solvent absorption, and chemical resistance, do not translate to ease of bonding. Moreover, polymers typically exhibit relatively low surface energy, poor wetting, and therefore exhibit relatively poor bonding characteristics.

For some applications, such as downhole applications or use of optical fibers as communication lines over long distances, the length of an optical fiber cable structure can be relatively long (e.g., greater than one kilometer). Treating the surface of such a long optical fiber cable structure to improve bonding characteristics of the surface can be relatively challenging. A system that treats the optical fiber cable structure on a section-by-section batch basis can be relatively time consuming, since the each section has to be individually treated before the next section can be treated. Also, in some cases, the surface of a cladding layer that has been treated to improve its adhering characteristics may exhibit such improved adhering characteristics for a relatively limited amount of time. Any process that requires a relatively long period of time to treat all target sections of the relatively long optical fiber cable structure can result in deterioration of adhering characteristics of certain parts of the treated surfaces of the cladding layer as time passes.

In accordance with some embodiments of the invention, techniques or mechanisms are provided to enable inline treatment of a surface of an optical fiber cable structure, which can be the surface of a cladding layer surrounding an optical fiber. The inline treatment of the surface of the optical fiber cable structure uses an inline plasma treatment system, in which the optical fiber cable structure is moved through the inline plasma treatment system so that the surface of the optical fiber cable structure can be continually exposed to plasma generated in the inline plasma treatment system. Exposing the surface of the optical fiber cable structure to plasma modifies a characteristic of the surface of the optical fiber cable structure (such as the surface of a cladding layer) to improve an ability of the surface of the optical fiber cable structure to adhere to a target structure (e.g., another structure that is part of an optical fiber sensor assembly, for example).

The inline plasma treatment of a surface of the optical fiber cable structure allows for inline, continual plasma treatment of substantially an entire length of the optical fiber cable structure. The inline plasma treatment of substantially the entire length of the optical fiber cable structure allows for the treatment to be completed in a smaller amount of time than would be involved in batch processing different segments of the optical fiber cable structure, one individual segment at a time. “Substantially the entire length of the optical fiber cable structure” refers to greater than 50% of the entire length of the optical fiber cable structure. More specifically, “substantially the entire length of the optical fiber cable structure” refers to greater than 75%, 80%, 85%, 90%, or 95% of the entire length of the optical fiber cable structure.

With quicker completion of the plasma treatment of the surface of the optical fiber cable structure, the improved adhering characteristic of the surface of the optical fiber cable structure can be maintained during the next step of manufacturing an assembly that includes the optical fiber cable structure. In some embodiments, an adhesive layer (e.g., a potting compound) can be dispensed onto the plasma treated surface of the cladding layer. The formation of the adhesive layer on the surface of the cladding layer allows for a further structure to be reliably attached to the cladding layer.

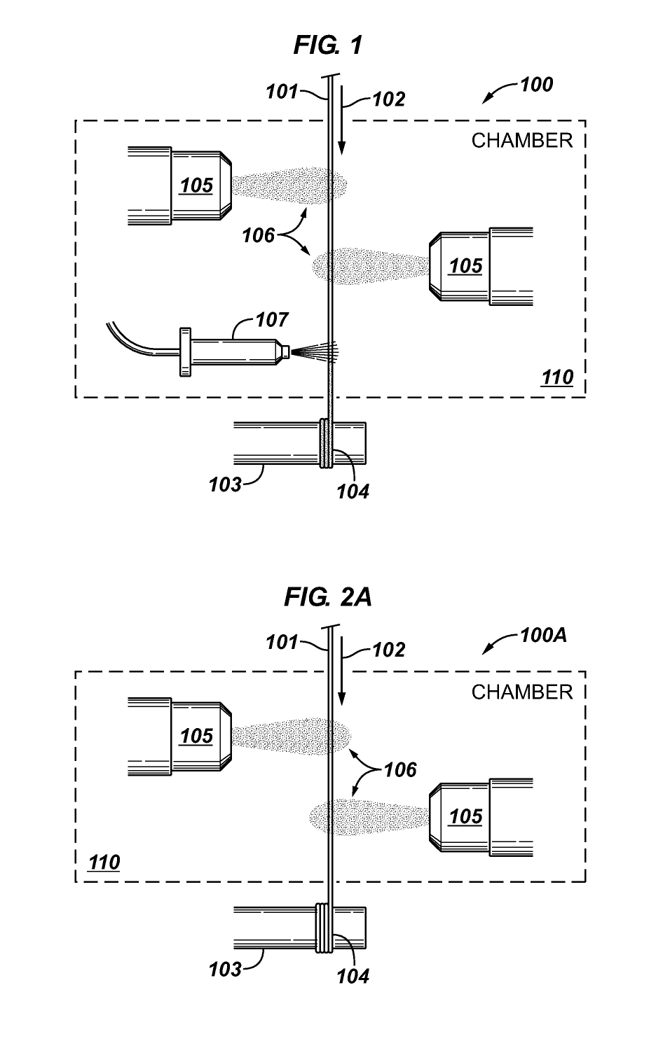

FIG. 1 is a schematic diagram of an example of an inline plasma treatment system in which an optical fiber cable structure 101 (which includes an optical fiber surrounded by a cladding layer) is drawn through a chamber 110 of the inline plasma treatment system 100. The chamber 110 can be a sealed chamber that isolates the chamber 110 from an environment external to the inline plasma treatment system 100.

Within the chamber 110, one or more plasma dispensers 105 are provided. Multiple (two or more) plasma dispensers 105 can be provided to provide coverage on different sides of the optical fiber cable structure 101. Each of the plasma dispensers 105 produces a respective jet 106 of plasma that is directed to the surface of the optical fiber cable structure 101.

Plasma is a partially ionized gas, in which a certain proportion of electrons are free rather than being bound to an atom or molecule. The plasma dispenser 105 thus directs charged particles that are accelerated towards the surface to be treated. The charged particles are accelerated to energies that are comparable or exceed the bond energies of the surface to be treated. Upon striking the surface to be treated, each charged particle may experience one or more of the following: be reflected, cause ejection of an electron or atom from the surface, be trapped within the surface, and/or cause impact that results in structural re-arrangement or that promotes chemical modification.

One type of an inline plasma treatment system is a dielectric barrier discharge system, in which the chamber 110 used is an atmospheric chamber. The dielectric barrier discharge system is able to produce a plasma gas including one or more of the following: argon, ammonia, nitrogen, oxygen, air, and so forth. An atmospheric plasma system includes a radio frequency (RF) high-voltage generator and multiple plasma dispensers, such as the dispensers 105 shown in FIG. 1. A plasma is generated within a body of the plasma dispenser 105, and a directed flow of air (or other gas) is provided along the discharge section to detach a portion of the plasma and to transport the detached portion of the plasma through a nozzle of the plasma dispenser 105 to the surface to be treated.

Directed atmospheric plasmas (such as nitrogen or oxygen atmospheric plasmas) may have one or more of the following effects. Cleaning effects involve the airflow driving microscopic objects from the surface to be treated. The ionized gas includes highly reactive free radicals, which react with organic contaminants to produce volatile compounds, such as water vapor, carbon monoxide, or carbon dioxide. The volatile compounds migrate away from the treated surface. Another possible effect of atmospheric plasma is that the atmospheric plasma may split long polymer chains on the surface to be treated. The atmospheric plasma can increase the oxygen-carbon ratio on the surface. Moreover, ablation/removal can be another effect, in which prolonged treatment reduces the thickness of the cladding layer. The treated surface is cleaned of organic contaminants, and thus has improved wetting and bonding characteristics.

To allow for formation of a composite assembly that includes the optical fiber cable structure 101, the optical fiber cable structure 101 is drawn through the chamber 110 of the inline plasma treatment system 100 by a movable structure 103, which in FIG. 1 is a rotatable winding mandrel 103. The optical fiber cable structure 101 is wound onto the mandrel 103 as the mandrel 103 rotates. Winding of the optical fiber cable structure 101 onto the mandrel 103 forms a coil 104 on the mandrel 103.

As the optical fiber cable structure 101 is drawn through the chamber 101 of the inline plasma treatment system 100, the plasma dispensers 105 continually produce plasma jets 106 for treating the surface of the optical fiber cable structure 101.

In the embodiment shown in FIG. 1, an adhesive dispenser 107 is also provided inside the chamber 110. The adhesive dispenser 107 dispenses an adhesive material onto the treated surface of the optical fiber cable structure 101, right after plasma treatment provided by the plasma dispensers 105. Thus, according to the FIG. 1 embodiment, the dispensing of the adhesive layer onto the surface of the optical fiber cable structure 101 is performed inline with plasma treatment, for a relatively efficient process.

The adhesive material dispensed by the adhesive dispenser 107 can be one or more of the following: cyanate ester, a polyester-based or ester-based resin, epoxy, polyimide, polyurethane, or rubber (e.g., vulcanized rubber or silicone rubber).

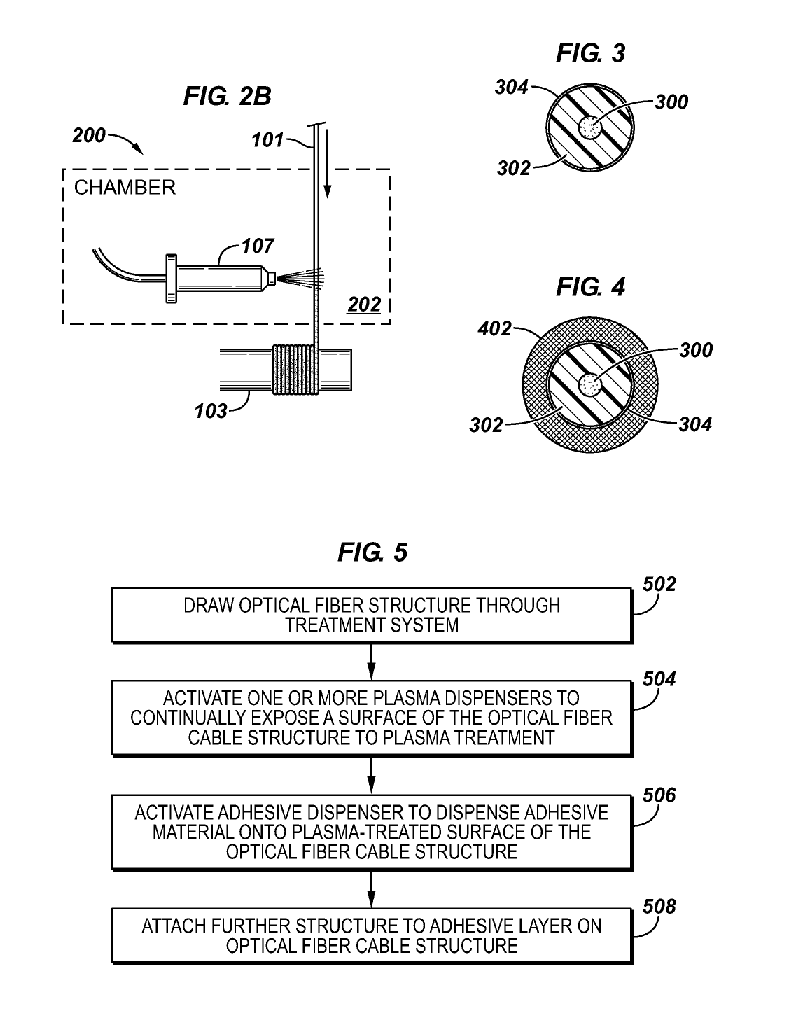

Alternatively, as depicted in FIGS. 2A and 2B, instead of providing the adhesive dispenser 107 inside the inline plasma treatment system 100, the adhesive dispenser 107 can be provided in a separate location. In FIG. 2A, an inline plasma treatment system 100A includes the same components as the system 100 of FIG. 1, except that the adhesive dispenser 107 is omitted. In FIG. 2A, the mandrel 103 winds the optical fiber cable structure 101 onto the mandrel 103 to draw the optical fiber cable structure 101 through the chamber 110. After plasma treatment of the optical fiber cable structure surface is completed, the optical fiber cable structure 101 is coiled onto the rotatable mandrel 103.

The rotatable mandrel 103 can then be moved to a separate location, such as the location of an adhesive dispensing system 200 that includes the adhesive dispenser 107. The mandrel 103 can then be rotated to unwind the optical fiber cable structure 101, such that the optical fiber cable structure 101 can be drawn through a chamber 202 of the adhesive dispensing system 200. The adhesive dispenser 107 in the chamber 202 can then dispense an adhesive material onto the plasma treated surface of the optical fiber cable structure 101 as the optical fiber cable structure 101 is unwound from the mandrel 103 and drawn through the chamber 202.

FIG. 3 is a cross-sectional view of an assembly that includes an optical fiber 300, a cladding layer 302, and an adhesive layer 304 (after processing by the inline plasma treatment system 100 of FIG. 1 or inline plasma treatment system 100A and adhesive dispensing system 200 of FIGS. 2A-2B). In FIG. 3, the optical fiber 300 is surrounded by (e.g., coated with) the cladding layer 302 (e.g., a polymer layer). Moreover, the adhesive layer 304 is provided onto the outer surface of the cladding layer 302, after plasma treatment of the outer surface of the cladding layer 302.

FIG. 4 illustrates the attachment of a further structure 402 to the assembly shown in FIG. 3. The further structure 402 is adhered to the assembly of FIG. 3 using the adhesive layer 304. The further structure 402 can be a tube or a part of a mold-based RTM composite.

FIG. 5 is a flow diagram of a process of making an optical fiber assembly, in accordance with an embodiment. The optical fiber assembly is formed by starting with an optical fiber cable structure that has an optical fiber and a cladding layer around the optical fiber. The optical fiber structure is drawn (at 502) through a chamber of a system (e.g., system 100 of FIG. 1 or system 100A of FIG. 2A). One or more plasma dispensers 105 (FIG. 1 or 2A) are activated (at 504) to continually expose a surface of the optical fiber cable structure to plasma treatment as the optical fiber cable structure is drawn through the chamber.

After plasma treatment of the surface of the optical fiber cable structure, an adhesive dispenser (e.g., 107 in FIG. 1 or 2B) is activated (at 506) to dispense an adhesive material onto the plasma-treated surface of the optical fiber cable structure. The dispensing of the adhesive material by the adhesive dispenser 107 can be performed inline with plasma treatment (such as with the system 100 of FIG. 1), or can be performed after completion of the plasma treatment (such as with the system 200 of FIG. 2B).

Following formation of an adhesive layer on the optical fiber cable structure, a further structure (or further structures) can be attached (at 508) to the adhesive layer to form the optical fiber assembly, which in some examples can be an optical fiber sensor assembly.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of treating a surface of an optical fiber cable structure, comprising:
moving substantially an entire length of the optical fiber cable structure through an inline plasma treatment system; and
as the optical fiber cable structure is moved through the inline plasma treatment system, continually exposing the surface of the optical fiber cable structure to plasma,
wherein exposing the surface of the optical fiber cable structure to plasma modifies a characteristic of the surface of the optical cable structure to improve an ability of the surface of the optical fiber cable structure to adhere to a target material, and
wherein the surface of the substantially the entire length of the optical fiber cable structure is exposed to the plasma.

2. The method of claim 1, further comprising:
adhering the target material to the surface of the optical fiber cable structure.

3. The method of claim 2, wherein adhering the target material comprises adhering an adhesive layer to the surface of the optical fiber cable structure.

4. The method of claim 3, wherein the adhesive layer includes a material selected from the group consisting of cyanate ester, resin, epoxy, polyimide, polyurethane, and rubber.

5. The method of claim 2, wherein adhering the target material comprises dispensing the target material onto the surface of the optical fiber cable structure using a target material dispenser.

6. The method of claim 5, wherein using the target material dispenser comprises using the target material dispenser that is part of the inline plasma treatment system.

7. The method of claim 5, wherein using the target material dispenser comprises using the target material dispenser that is separate from the inline plasma treatment system.

8. The method of claim 1, wherein moving the substantially the entire length of the optical fiber cable structure through the inline plasma treatment system comprises winding the optical fiber cable structure into a winding mandrel.

9. The method of claim 1, wherein exposing the surface of the optical fiber cable structure to plasma comprises exposing the surface of the optical fiber cable structure to atmospheric plasma.

10. The method of claim 1, wherein exposing the surface of the optical fiber cable structure to plasma comprises exposing a surface of a cladding layer surrounding an optical fiber.

11. The method of claim 1, wherein treating the surface of the optical fiber cable structure comprises treating the surface of the optical fiber cable structure through which a light signal is to be transmitted.

12. A system comprising:
one or more plasma dispensers; and
a movable structure configured to move substantially an entire length of an optical fiber cable structure past the one or more plasma dispensers,
wherein the one or more plasma dispensers are configured to produce plasma to treat a surface of the optical fiber cable structure as the optical fiber cable structure is moved past the one or more plasma dispensers to improve an ability of the optical fiber to adhere to a target material, and
wherein movement of the substantially the entire length of the optical fiber cable structure past the one or more plasma dispensers causes the surface of the substantially the entire length of the optical fiber cable structure to be subjected to treatment by the plasma produced by the one or more plasma dispensers.

13. The system of claim 12, wherein the movable structure comprises a winding mandrel.

14. The system of claim 12, further comprising a target material dispenser system to dispense the target material onto the plasma-treated surface of the optical cable structure.

15. The system of claim 14, wherein the target material is an adhesive material.

16. A method of making an optical fiber assembly, comprising:
running a structure including an optical fiber and a cladding layer around the optical fiber through an inline plasma treatment system;
exposing a surface of the cladding layer to plasma produced in the inline plasma treatment system; and
dispensing a target material onto the surface of the cladding layer after plasma exposure to adhere the target material to the surface of the cladding layer,
wherein substantially an entire length of the cladding layer is exposed to the plasma using the inline plasma treatment system.

17. The method of claim 16, wherein dispensing the target material is performed inline with exposing the surface of the cladding layer to the plasma.

18. The method of claim 16, wherein dispensing the target material is performed after the substantially the entire length of the cladding layer has been exposed to the plasma.

19. The method of claim 16, wherein the cladding layer includes a polymer.

20. The method of claim 16, wherein the target material is an adhesive material.

21. The method of claim 20, further comprising dispensing a further structure onto the adhesive material to form the optical fiber assembly including the optical fiber, cladding layer, and the further structure.
